(19) United States
(12) Patent Application Publication
(10) Pub. No.: US 2019/0289614 A1
(43) Pub. Date: Sep. 19, 2019

(54) DATA TRANSMISSION METHOD AND APPARATUS

(71) Applicant: ZTE CORPORATION, Shenzhen, Guangdong (CN)

(72) Inventors: Xincai LI, Shenzhen (CN); Yajun ZHAO, Shenzhen (CN); Ling YANG, Shenzhen (CN); Hanqing XU, Shenzhen (CN)

(21) Appl. No.: 16/322,822

(22) PCT Filed: Aug. 2, 2017
(86) PCT No.: PCT/CN2017/095646

§ 371 Date: May 23, 2019

(30) Foreign Application Priority Data
Aug. 12, 2016 (CN) 201610666398.1

(51) Int. Cl. H04W 72/10; H04W 74/08; H04W 72/04

(52) U.S. Cl. CPC H04W 72/10; H04W 72/0453; H04W 72/0446; H04W 74/0833

(57) ABSTRACT

A data transmission method includes: determining a carrier priority to be used according to a traffic type; performing channel contention by performing a clear channel assessment (CCA) process according to the carrier priority and using a preset CCA mechanism; and sending data of the traffic type on a contended channel.

### TECHNICAL FIELD

The present application relates to, but is not limited to, mobile communication technologies and, in particular, relates to a data transmission method and apparatus.

### BACKGROUND

The 5th-generation (5G) mobile communication technology needs to solve some challenges posed by diverse application scenarios. For example, the low-latency high-reliable applications have high requirements on the latency and the reliability and need to provide users with a millisecond-level end-to-end latency and guarantee a service reliability of nearly 100%. Meanwhile, the limited licensed carrier resources cannot meet the requirements of large-capacity communications. The use of unlicensed carriers or shared carriers will significantly enhance potential spectrum resources of a communication system and reduce spectrum costs of operators, which is a future communication development trend.

However, the use of unlicensed carriers has many problems such as regulation policies for the use of unlicensed spectra in some countries and regions. For example, in Europe, a station is required to perform a listen before talk (LBT) mechanism before sending data, that is, a clear channel assessment (CCA) or an enhanced clear channel assessment (eCCA) is required before data transmission. The eCCA refers to the detection on the number of times the corresponding random backoff is performed.

Currently, some unlicensed or shared carrier bands are already used by Vehicle-to-Everything techniques. If some traffic types of applications of the 5G are also transmitted on the unlicensed carriers with still using the original CCA process or mechanism, an access latency would be very large. Moreover, if a time at which the CCA succeeds is far from a predefined time at which data transmission is allowed, the station needs to continuously transmit an occupancy signal, resulting in low spectrum efficiency.

### SUMMARY

The following is a summary of the subject matter described herein in detail. This summary is not intended to limit the scope of the claims.

The present disclosure provides a data transmission method and apparatus to satisfy fairness between different systems and improve a resource utilization.

In a first aspect, an embodiment of the present disclosure provides a data transmission method. The method includes the steps described below.

A carrier priority to be used is determined according to a traffic type; Channel contention is performed by performing a clear channel assessment (CCA) process according to the carrier priority and using a preset CCA mechanism.

Data of the traffic type is sent on a contended channel.

In an exemplary embodiment, the preset CCA mechanism may include:

not executing the CCA, executing an one-detection CCA, and executing the CCA with random backoff.

In an exemplary embodiment, the executing the CCA with random backoff may include the step described below.

The CCA succeeds when a backoff value decreases to a predetermined value.

Alternatively, another CCA of a predefined length is executed at a predefined time after the backoff value decreases to the predetermined value.

Alternatively, the CCA is executed by way of adjusting a LBT contention window or a CCA backoff value.

In an exemplary embodiment, before the carrier priority to be used is determined according to the traffic type, the method may further include the step described below.

Carriers are configured with a plurality of carrier priorities, where carriers of different carrier priorities are configured to send data of different traffic types.

In an exemplary embodiment, the step of adjusting the LBT contention window or the CCA backoff value may include one of the steps described below.

The LBT contention window or the CCA backoff value is decreased in response to an incorrect data packet transmission on a predetermined reference subframe.

The LBT contention window or the CCA backoff value is increased in response to an correct data packet transmission on the predetermined reference subframe.

The LBT contention window or the CCA backoff value is decreased in response to determining that a transmission data packet is not successfully sent at a predetermined reference time or is successfully sent after the predetermined reference time.

The LBT contention window or the CCA backoff value is increased in response to determining that the transmission data packet is successfully sent before the predetermined reference time.

The LBT contention window or the CCA backoff value is decreased in response to determining that a number of times a channel is busy within a predetermined time exceeds a first threshold.

The LBT contention window or the CCA backoff value is increased in response to determining that a number of times the channel is idle within the predetermined time exceeds a second threshold.

The LBT contention window or the CCA backoff value is decreased in response to determining that the number of times the channel is busy, a number of channel busy timeslots, a ratio of the number of channel busy timeslots to a total number of CCA timeslots, or a number of failed CCAs exceeds a third threshold within the predetermined time.

The LBT contention window or the CCA backoff value is increased in response to determining that the number of times the channel is idle, a number of channel idle timeslots, a ratio of the number of channel idle timeslots to the total number of CCA timeslots, or a number of successful CCAs exceeds a fourth threshold within the predetermined time.

A size of the LBT contention window or a size of the CCA backoff value is determined according to indication information sent by a predetermined node.

In an exemplary embodiment, the step in which the LBT contention window or the CCA backoff value is decreased may include the step described below.

The LBT contention window or the CCA backoff value is adjusted to a preset minimum value or a half of a current value or a ceiling of the half of the current value or a floor of the half of the current value.

The step in which the LBT contention window or the CCA backoff value is increased may include the step described below.

The LBT contention window or the CCA backoff value is doubled.

In an exemplary embodiment, the step in which the size of the LBT contention window or the size of the CCA backoff value is determined according to the indication information sent by the predetermined node may include the step described below.

Feedback information sent by the predetermined node according to a data receiving situation is received to adjust the size of the LBT contention window or the size of the CCA backoff value.

Alternatively, the size of the LBT contention window or the size of the CCA backoff value is determined according to the indication information.

In an exemplary embodiment, the executing one-detection CCA may include the step described below.

One CCA is executed in each frame period. A starting position of the one CCA is randomly selected within a preset time window, where the preset time window is one timeslot or one subframe or one orthogonal frequency division multiplexing (OFDM) symbol.

In an exemplary embodiment, the step of sending the data of the traffic type on the contended channel may include the step described below.

Muting according to a predefined time domain pattern, or sending the data of the traffic type in a dynamic on/off manner.

In an exemplary embodiment, in response to not executing the CCA, the step of sending the data of the traffic type may include the step described below.

The data of the traffic type is transmitted on a contended unlicensed carrier with deleting transmission time intervals (TTI) or frequency domain resources of other traffic types except the present traffic type.

In an exemplary embodiment, before the data of the traffic type is sent, the method may further include the step described below.

A length of the TTI of a data transmission is determined, or the length of the TTI of the data transmission is selected from candidate TTI lengths.

In an exemplary embodiment, the step of determining the length of the TTI of the data transmission may include one of the steps described below.

A length of an initial TTI or a length of an initial subframe within a channel occupation time is determined according to a time domain length between a CCA success time and a subframe boundary.

A length of a last TTI or a length of a last subframe within the channel occupation time is determined according to a difference between an occupied time and a maximum channel occupation time (MCOT).

A length of a TTI within the channel occupation time is determined according to a predefinition or network configuration.

In an exemplary embodiment, the step of selecting the length of the TTI of the data transmission from the candidate TTI lengths may include the steps described below.

A TTI length closest to t1 is selected from the candidate TTI lengths as a length of an initial subframe of the data transmission.

A TTI length closest to t2 is selected from the candidate TTI lengths as a length of a last subframe of the data transmission.

More than two TTI lengths are selected from the candidate TTI lengths, and the combination length of the selected more than two TTI lengths is closest to t1 or t2 and used as a subframe length in the data transmission.

t1 is a time domain length between the CCA success time and a subframe boundary, and t2 is a difference between the occupied time duration and the MCOT.

In an exemplary embodiment, the length of the initial TTI and the length of the last TTI within the channel occupation time are less than or equal to a length of an intermediate TTI within the channel occupation time.

In a second aspect, an embodiment of the present disclosure provides a data transmission method. The method includes the steps described below.

A TTI length of a data transmission is determined.

Transmitted data is received on a corresponding carrier according to the TTI length.

In an exemplary embodiment, the step in which the TTI length of the data transmission is determined may include the step described below.

Blind detection is performed according to a predefined candidate TTI set on the corresponding carrier to obtain the TTI length, or the TTI length is obtained according to indication information.

In a third aspect, an embodiment of the present disclosure provides a data transmission apparatus, including a priority module, an execution module and a transmission module.

The priority module is configured to determine a carrier priority to be used according to a traffic type;

The execution module is configured to perform channel contention by performing a clear channel assessment (CCA) process according to the carrier priority and using a preset CCA mechanism.

The transmission module is configured to send data of the traffic type on a contended channel.

In an exemplary embodiment, the preset CCA mechanism executed by the execution module may include: not executing the CCA, executing one-detection CCA, and executing the CCA with random backoff.

In an exemplary embodiment, the execution module may be configured to execute the CCA with the random backoff in the manner described below.

The CCA succeeds when a backoff value decreases to a predetermined value.

Alternatively, another CCA of a predefined length is executed at a predefined time after the backoff value decreases to the predetermined value.

Alternatively, the CCA is executed by way of adjusting a LBT contention window or a CCA backoff value.

In an exemplary embodiment, the apparatus may further include a division module.

The division module is configured to configure carriers with carrier priorities, where carriers of different carrier priorities are configured to send data of different traffic types.

In an exemplary embodiment, the execution module may be configured to adjust the LBT contention window or the CCA backoff value in one of the manners described below.

The LBT contention window or the CCA backoff value is decreased in response to a failed data packet transmission on a predetermined reference subframe.

The LBT contention window or the CCA backoff value is increased in response to a successful data packet transmission on the predetermined reference subframe.

The LBT contention window or the CCA backoff value is decreased in response to determining that a transmitted data packet is not successfully sent at a predetermined reference time or is successfully sent after the predetermined reference time.

The LBT contention window or the CCA backoff value is increased in response to determining that the transmitted data packet is successfully sent before the predetermined reference time.

The LBT contention window or the CCA backoff value is decreased in response to determining that a number of times a channel is busy within a predetermined time exceeds a first threshold.

The LBT contention window or the CCA backoff value is increased in response to determining that a number of times the channel is idle within the predetermined time exceeds a second threshold.

The LBT contention window or the CCA backoff value is decreased in response to determining that the number of times the channel is busy, a number of channel busy timeslots, a ratio of the number of channel busy timeslots to a total number of CCA timeslots, or a number of failed CCAs exceeds a third threshold within the predetermined time.

The LBT contention window or the CCA backoff value is increased in response to determining that the number of times the channel is idle, a number of channel idle timeslots, a ratio of the number of channel idle timeslots to the total number of CCA timeslots, or a number of successful CCAs exceeds a fourth threshold within the predetermined time.

A size of the LBT contention window or a size of the CCA backoff value is determined according to indication information sent by a predetermined node.

In an exemplary embodiment, the execution module may be configured to determine the size of the LBT contention window or the size of the CCA backoff value according to the indication information sent by the predetermined node in the manner described below.

The execution module receives feedback information sent by the predetermined node according to a data receiving situation to adjust the size of the LBT contention window or the size of the CCA backoff value.

Alternatively, the execution module determines the size of the LBT contention window or the size of the CCA backoff value according to the indication information.

In an exemplary embodiment, the execution module may be configured to execute the one-detection CCA in the manner described below.

In each frame period, the execution module executes one CCA. A starting position of the one CCA is randomly selected within a preset time window, where the preset time window is one timeslot or one subframe or one orthogonal frequency division multiplexing (OFDM) symbol.

In an exemplary embodiment, the transmission module may be configured to send the data of the traffic type on the contended channel in the manner described below.

The transmission module mutes according to a predefined time domain pattern, or sends the data of the traffic type in a dynamic on/off manner.

In an exemplary embodiment, in response to not executing the CCA, the transmission module may be configured to send the data of the traffic type in the manner described below.

The transmission module transmits the data of the traffic type on a contended unlicensed carrier with deleting TTIs or frequency domain resources of other traffic types except the traffic type.

In an exemplary embodiment, the transmission module may be further configured to:

determine a length of a transmission time interval (TTI) in a data transmission, or select the length of the TTI in the data transmission from candidate TTI lengths.

In an exemplary embodiment, the transmission module may be configured to determine the length of the TTI in the data transmission in the manner described below.

The transmission module determines a length of an initial TTI or a length of an initial subframe within a channel occupation time according to a time domain length between a CCA success time and a subframe boundary.

Alternatively, the transmission module determines a length of a last TTI or a length of a last subframe within the channel occupation time according to a difference between an occupied time duration and a MCOT.

Alternatively, the transmission module determines a length of a TTI within the channel occupation time according to a predefinition or network configuration.

In an exemplary embodiment, the transmission module may be configured to select the length of the TTI in the data transmission from the candidate TTI lengths in the manners described below.

The transmission module determines selects a TTI length closest to t1 from the candidate TTI lengths as a length of an initial subframe in the data transmission.

The transmission module determines selects a TTI length closest to t2 from the candidate TTI lengths as a length of a last subframe in the data transmission.

The transmission module determines selects more than two TTI lengths from the candidate TTI lengths, and a combination length of the more than two TTI lengths is closest to t1 or t2 and used as a subframe length in the data transmission.

t1 is a time domain length between a CCA success time and a subframe boundary, and t2 is a difference between an occupied time and a maximum channel occupation time (MCOT).

In a fourth aspect, an embodiment of the present disclosure provides a data transmission apparatus, including a determination module and a receiving module.

The determination module is configured to determine a TTI length in a data transmission; and

The receiving module is configured to receive transmitted data on a corresponding carrier according to the TTI length.

In an exemplary embodiment, the determination module may be configured to determine the TTI length in the data transmission in the manner described below.

The determination module performs blind detection according to a predefined candidate TTI set on the corresponding carrier to obtain the TTI length, or the determination module obtains the TTI length according to indication information.

In addition, an embodiment of the present disclosure further provides a computer-readable medium, storing programs used for data transmission. The programs, when executed by a processor, implement the steps of the data transmission method in the first aspect.

In addition, an embodiment of the present disclosure further provides a computer-readable medium, storing programs used for data transmission. The programs, when executed by a processor, implement the steps of the data transmission method in the second aspect.

The data transmission methods based on the CCA according to the embodiments of the present disclosure provide feasibility of sending traffic with a higher requirement for low latency on the unlicensed carrier. The methods according to the embodiments of the present disclosure may ensure not only fairness between operators and the different systems but also ensure that traffic with a lower requirement for low latency to be sent is preferentially sent on the unlicensed carrier, reducing a data transmission latency. In addition, a station flexibly selects the length of the initial subframe according to the subframe alignment relationship of the CCA success time, and selects the length of the last subframe according to a difference between the occupied time and the MCOT, improving a resource utilization rate within the channel occupation time and reducing the transmission of an original occupation signal.

Other aspects can be understood after the drawings and detailed description are read and understood.

### BRIEF DESCRIPTION OF DRAWINGS

FIG. 1 is a flowchart of a data transmission method according to an embodiment of the present disclosure;

FIG. 2 is a flowchart of another data transmission method according to an embodiment of the present disclosure;

FIG. 3 is a structural diagram of a data transmission apparatus according to an embodiment of the present disclosure;

FIG. 4 is a structural diagram of another data transmission apparatus according to an embodiment of the present disclosure;

FIG. 5 is a flowchart of a CCA process and a data transmission performed by a station according to an exemplary embodiment of the present disclosure;

FIG. 6 is a schematic diagram of a frame structure in a data transmission according to an exemplary embodiment of the present disclosure; and

FIG. 7 is a schematic diagram of different TTI lengths used in a data transmission according to an exemplary embodiment of the present disclosure.

### DETAILED DESCRIPTION

Embodiments of the present disclosure will be described below in conjunction with the drawings.

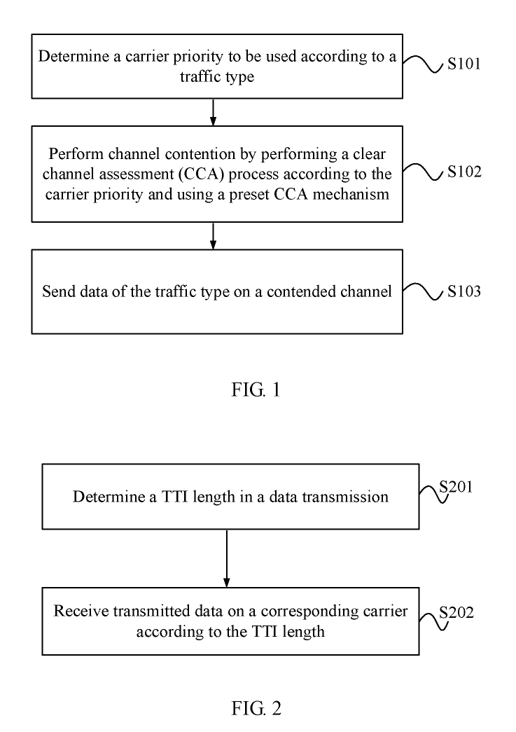

FIG. 1 is a flowchart of a data transmission method according to an embodiment of the present disclosure. As shown in FIG. 1, the data transmission method in the embodiment includes the steps described below.

In step S101, a carrier priority to be used is determined according to a traffic type.

In step S102, channel contention is performed by performing a clear channel assessment (CCA) process according to the carrier priority and using a preset CCA mechanism.

In step S103, data of the traffic type is sent on a contended channel.

The preset CCA mechanism in step S102 may include:

not executing the CCA, executing one-detection CCA, and executing the CCA with random backoff.

The executing the CCA with the random backoff may include the step described below.

The CCA succeeds when a backoff value decreases to a predetermined value.

Alternatively, another CCA of a predefined length is executed at a predefined time after the backoff value decreases to the predetermined value.

Alternatively, the CCA is executed by way of adjusting a LBT contention window or a CCA backoff value.

Before step S101, the method in the embodiment may further include the step described below.

Carriers are configured with carrier priorities, where carriers of different carrier priorities are configured to send data of different traffic types.

The carrier priorities are determined by way of negotiations between operators. After the carrier priorities are determined, the data of different traffic types is sent on corresponding carriers. On carriers with higher priorities, when the station executes the CCA process, the station may adopt an adjustment mechanism of a contention window or the backoff value for sending a traffic type with higher requirement for low latency.

If there is a conflict, the contention window or the backoff value is decreased in a next CCA to increase a contention success possibility.

The LBT contention window or the CCA backoff value may be adjusted according to one of the following parameters:

the number of times a channel is busy/idle, the number of channel busy/idle timeslots, a ratio of the number of channel busy/idle timeslots to a total number of CCA timeslots, a number of failed CCAs or a number of successful CCAs;

a value or a proportion of corresponding ACK/NACK in a reference subframe or a reference data burst subframe; and

indication information from a predetermined node for determining the LBT contention window.

The step of adjusting the LBT contention window or the CCA backoff value may include one of the steps described below.

The LBT contention window or the CCA backoff value is decreased in response to a failed data packet transmission on a predetermined reference subframe.

The LBT contention window or the CCA backoff value is increased in response to a successful data packet transmission on the predetermined reference subframe.

The LBT contention window or the CCA backoff value is decreased in response to a transmission data packet being not successfully sent at a predetermined reference time or is successfully sent after the predetermined reference time.

The LBT contention window or the CCA backoff value is increased in response to the transmission data packet being successfully sent before the predetermined reference time.

The LBT contention window or the CCA backoff value is decreased in response to the number of times the channel being busy within a predetermined time exceeds a first threshold.

The LBT contention window or the CCA backoff value is increased in response to determining that the number of times the channel is idle within the predetermined time exceeds a second threshold.

The LBT contention window or the CCA backoff value is decreased in response to the number of times the channel is busy, the number of channel busy timeslots, the ratio of the number of channel busy timeslots to the total number of CCA timeslots, or the number of failed CCAs exceeding a third threshold within the predetermined time.

The LBT contention window or the CCA backoff value is increased in response to determining that the number of times the channel is idle, the number of channel idle timeslots, the ratio of the number of channel idle timeslots to the total number of CCA timeslots, or the number of successful CCAs exceeds a fourth threshold within the predetermined time.

A size of the LBT contention window or a size of the CCA backoff value is determined according to the indication information sent by the predetermined node.

The step of decreasing the LBT contention window or the CCA backoff value may include the step described below.

The LBT contention window or the CCA backoff value is adjusted to a preset minimum value or a half of a current value or a ceiling of the half of the current value or a floor of the half of the current value.

The step of increasing the LBT contention window or the CCA backoff value may include the step described below.

The LBT contention window or the CCA backoff value is doubled.

In the embodiment, the adjusted contention window and the adjusted backoff value is limited and do not exceed a maximum contention window of an LBT priority corresponding to the traffic type.

The step of determining the size of the LBT contention window or the size of the CCA backoff value is determined according to the indication information sent by the predetermined node may include the step described below.

Feedback information sent by the predetermined node according to a data receiving situation is received to adjust the size of the LBT contention window or the size of the CCA backoff value.

Alternatively, the size of the LBT contention window or the size of the CCA backoff value is determined according to the indication information.

The executing the one-detection CCA may include the step described below.

One CCA is executed in each frame period. A starting position of the one CCA is randomly selected within a preset time window, where the preset time window is one timeslot or one subframe or one orthogonal frequency division multiplexing (OFDM) symbol.

To ensure the fairness between different systems, the step of sending the data of the traffic type after a successful CCA may include the step described below.

Muting is performed according to a predefined time domain pattern, or the data of the traffic type is sent in a dynamic on/off manner.

In the case of not executing the CCA, the step of sending the data of the traffic type may include the step described below.

The data of the traffic type is transmitted on a contended unlicensed carrier with deleting transmission time intervals (TTI) or frequency domain resources of other traffic types except the traffic type.

Before the data of the traffic type is sent, the method in the embodiment may further include the step described below.

A length of the TTI in a data transmission is determined, or the length of the TTI in the data transmission is selected from candidate TTI lengths.

The step of determining the length of the TTI in the data transmission may include one of the steps described below.

A length of an initial TTI or a length of an initial subframe within a channel occupation time is determined according to a time domain length between a CCA success time and a subframe boundary.

A length of a last TTI or a length of a last subframe within the channel occupation time is determined according to a difference between an occupied time and a maximum channel occupation time (MCOT).

A length of a TTI within the channel occupation time is determined according to a predefinition or network configuration.

In the embodiment, the station may also combine predefined TTI lengths or configured TTI lengths into the most suitable TTI length for the data transmission. The length of the TTI is flexibly selected to improve the resource utilization rate and reduce or avoid the transmission of an occupation signal.

The step of selecting the length of the TTI in the data transmission from the candidate TTI lengths may include the steps described below.

A TTI length closest to t1 is selected from the candidate TTI lengths as a length of an initial subframe in the data transmission.

A TTI length closest to t2 is selected from the candidate TTI lengths as a length of a last subframe in the data transmission.

More than two TTI lengths are selected from the candidate TTI lengths, and a combination length of the more than two TTI lengths is closest to t1 or t2 and used as a subframe length in the data transmission.

t1 is the time domain length between the CCA success time and the subframe boundary, and t2 is the difference between the occupied time and the MCOT.

Each of the length of the initial TTI and the length of the last TTI within the channel occupation time is less than or equal to a length of an intermediate TTI within the channel occupation time.

FIG. 2 is a flowchart of another data transmission method according to an embodiment of the present disclosure. As shown in FIG. 2, the data transmission method in the embodiment includes the steps described below.

In step S201, a TTI length in a data transmission is determined.

In step S202, transmission data is received on a corresponding carrier according to the TTI length.

The step of determining the TTI length in the data transmission may include the step described below.

Blind detection is performed according to a predefined candidate TTI set on the corresponding carrier to obtain the TTI length, or the TTI length is obtained according to indication information.

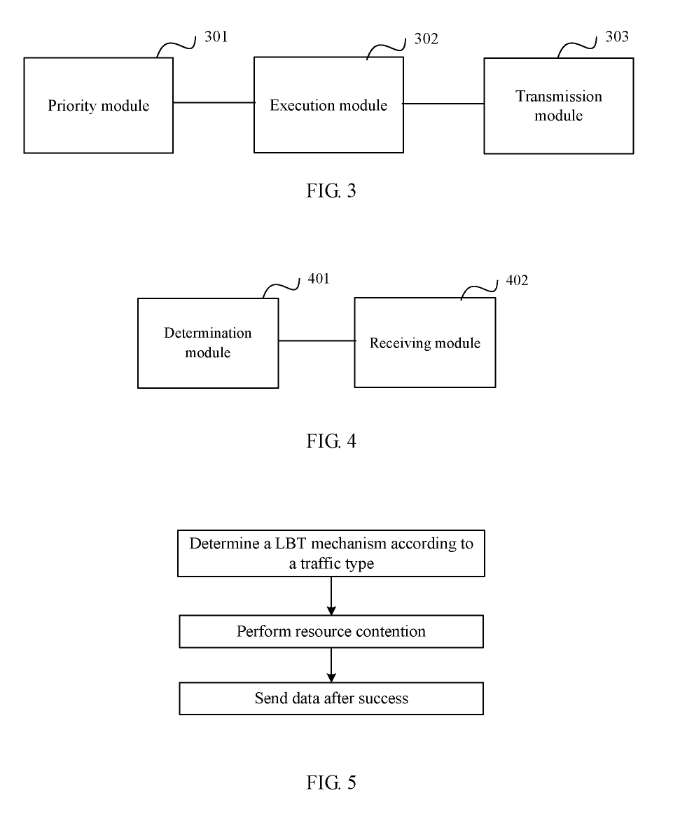

FIG. 3 is a structural diagram of a data transmission apparatus according to an embodiment of the present disclosure. As shown in FIG. 3, the data transmission apparatus in the embodiment includes a priority module 301, an execution module 302 and a transmission module 303.

The priority module 301 is configured to determine a carrier priority to be used according to a traffic type.

The execution module 302 is configured to perform channel contention by performing a CCA process according to the carrier priority and using a preset CCA mechanism.

The transmission module 303 is configured to send data of the traffic type on a contended channel.

The preset CCA mechanism executed by the execution module 302 may include not executing the CCA, executing an one-detection CCA, and executing the CCA with random backoff.

The execution module 302 is configured to execute the CCA with the random backoff in the manner described below.

The CCA succeeds when a backoff value decreases to a predetermined value.

Alternatively, another CCA of a predefined length is executed at a predefined time after the backoff value decreases to the predetermined value.

Alternatively, the CCA is executed by way of adjusting a LBT contention window or a CCA backoff value.

The apparatus in the embodiment may further include a division module. The division module is configured to configure carriers with a plurality of carrier priorities, where carriers of different carrier priorities are configured to send data of different traffic types.

The execution module 302 may be configured to adjust the LBT contention window or the CCA backoff value in one of the manners described below.

The LBT contention window or the CCA backoff value is decreased in response to a failed data packet transmission on a predetermined reference subframe.

The LBT contention window or the CCA backoff value is increased in response to a successful data packet transmission on the predetermined reference subframe.

The LBT contention window or the CCA backoff value is decreased in response to determining that a transmitted data packet is not successfully sent at a predetermined reference time or is successfully sent after the predetermined reference time.

The LBT contention window or the CCA backoff value is increased in response to determining that the transmitted data packet is successfully sent before the predetermined reference time.

The LBT contention window or the CCA backoff value is decreased in response to determining that a number of times a channel is busy within a predetermined time exceeds a first threshold.

The LBT contention window or the CCA backoff value is increased in response to determining that a number of times the channel is idle within the predetermined time exceeds a second threshold.

The LBT contention window or the CCA backoff value is decreased in response to determining that the number of times the channel is busy, a number of channel busy timeslots, a ratio of the number of channel busy timeslots to a total number of CCA timeslots, or a number of failed CCAs exceeds a third threshold within the predetermined time.

The LBT contention window or the CCA backoff value is increased in response to determining that the number of times the channel is idle, a number of channel idle timeslots, a ratio of the number of channel idle timeslots to the total number of CCA timeslots, or a number of successful CCAs exceeds a fourth threshold within the predetermined time.

A size of the LBT contention window or a size of the CCA backoff value is determined according to indication information sent by a predetermined node.

The execution module 302 may be configured to determine the size of the LBT contention window or the size of the CCA backoff value according to the indication information sent by the predetermined node in the manner described below.

The execution module receives feedback information sent by the predetermined node according to a data receiving situation to adjust the size of the LBT contention window or the size of the CCA backoff value.

Alternatively, the execution module determines the size of the LBT contention window or the size of the CCA backoff value according to the indication information.

The execution module 302 is configured to execute the one-detection CCA in the manner described below.

One CCA is executed in each frame period. A starting position of the one CCA is randomly selected within a preset time window, where the preset time window is one timeslot or one subframe or one OFDM symbol.

The transmission module 303 may be configured to send the data of the traffic type on the contended channel in the manner described below.

The transmission module mutes according to a predefined time domain pattern, or the transmission module sends the data of the traffic type in a dynamic on/off manner.

In the case of not executing the CCA, the transmission module 303 may be configured to send the data of the traffic type in the manner described below.

The data of the traffic type is transmitted on a contended unlicensed carrier in a manner of deleting TTIs or frequency domain resources of traffic types except the traffic type.

The transmission module 303 may be further configured to determine a length of a TTI in a data transmission, or select the length of the TTI in the data transmission from candidate TTI lengths.

The transmission module 303 may be configured to determine the length of the TTI in the data transmission in the manner described below.

A length of an initial TTI or a length of an initial subframe within a channel occupation time is determined according to a time domain length between a CCA success time and a subframe boundary.

Alternatively, a length of a last TTI or a length of a last subframe within the channel occupation time is determined according to a difference between an occupied time and a MCOT.

Alternatively, a length of a TTI within the channel occupation time is determined according to a predefinition or network configuration.

The transmission module 303 may be configured to select the length of the TTI in the data transmission from the candidate TTI lengths in the manners described below.

A TTI length closest to t1 is selected from the candidate TTI lengths as a length of an initial subframe in the data transmission.

A TTI length closest to t2 is selected from the candidate TTI lengths as a length of a last subframe in the data transmission.

More than two TTI lengths are selected from the candidate TTI lengths, and the combination length of the more than two TTI lengths is closest to t1 or t2 and used as a subframe length in the data transmission.

t1 is the time domain length between the CCA success time and the subframe boundary, and t2 is the difference between the occupied time and the MCOT.

FIG. 4 is a structural diagram of another data transmission apparatus according to an embodiment of the present disclosure. As shown in FIG. 4, the data transmission apparatus in the embodiment includes a determination module 401 and a receiving module 402.

The determination module 401 is configured to determine a TTI length in a data transmission.

The receiving module 402 is configured to receive transmission data on a corresponding carrier according to the TTI length.

The transmission module 401 may be configured to determine the TTI length in the data transmission in the manner described below.

The transmission module performs blind detection according to a predefined candidate TTI set on the corresponding carrier to obtain the TTI length, or the transmission module obtains the TTI length according to indication information.

The present application will be described below through multiple embodiments.

FIG. 5 is a flowchart of a CCA process and a data transmission performed by a station according to an exemplary embodiment of the present disclosure. As shown in FIG. 5, the embodiment provides a method for performing CCA and data transmission. The method includes the steps described below.

The station determines a CCA mechanism according to a traffic type, and then executes the CCA corresponding to the CCA mechanism. The station sends data after the CCA succeeds.

The CCA mechanism includes not executing the CCA, executing one-detection CCA, and executing the CCA with random backoff.

The process of the CCA with the random backoff is as follows: a minimum contention window (CW) such as 3 or 7 is used for the first CCA; and the contention window of the subsequent CW is adjusted in one of the four manners described below.

Adjustment Manner 1

The station itself determines or adjusts the contention window according to one of the following parameters:

a number of times a channel is busy/idle, a number of channel busy/idle timeslots, a ratio of the number of channel busy/idle timeslots to a total number of CCA timeslots, a number of failed CCAs and a number of successful CCAs.

An adjustment principle is as follows.

In response to determining that the number of times the channel is busy exceeds a threshold, the CW or a backoff value is adjusted to a minimum value, or a half of a previous value, or a ceiling of a half of the previous value, or a floor of a half of the previous value.

In response to determining that the number of times the channel is idle exceeds a threshold, the CW or the backoff value is adjusted to the minimum value.

Adjustment Manner 2

A transmitting terminal adjusts the CW according to a value or a proportion of an ACK/NACK, fed back by a receiving terminal, corresponding to a reference subframe or a reference uplink (UL) burst subframe.

For example, in response to determining that the receiving terminal feeds back an ACK for a data packet transmitted on the reference subframe, the contention window is adjusted to the minimum value. In response to determining that the receiving terminal feeds back an NACK for the data packet transmitted on the reference subframe, the transmitting terminal adjusts the value of the contention window or the backoff value to the minimum value.

Alternatively, in response to determining that a proportion of the NACK corresponding to data packets transmitted in a latest UL burst or in a predefined time window exceeds a threshold, the transmitting terminal adjusts the value of the contention window or the backoff value to the minimum value.

Adjustment Manner 3

The receiving terminal adjusts the CW according to a demodulation result of the reference subframe and sends the adjusted CW value to the transmitting terminal via signaling. In this manner, all CCA parameters used by the transmitting terminal are controlled and adjusted by a base station. The reference subframe is the latest subframe accessed and sent by executing the CCA with random backoff.

A principle for adjusting the CW may include the principle described below.

In response to determining that the receiving terminal incorrectly demodulates the data packet transmitted on the reference subframe, the value of the contention window is adjusted to the minimum value. In response to determining that the receiving terminal incorrectly demodulates the data packet transmitted on the reference subframe, the value of the contention window or the backoff value is adjusted to the minimum value.

Alternatively, in response to determining that a proportion of demodulation errors corresponding to the data packets transmitted in the latest UL burst or in the predefined time window exceeds a threshold, the base station adjusts the value of the contention window or the backoff value to the minimum value.

Adjustment Manner 4

The size of the contention window is adjusted according to a time sequence of a contention success time and a predetermined position.

If a time at which the station successfully executes the CCA is earlier than a reference time, the contention window or an N value is adjusted to the minimum value. If the time at which the station successfully executes the CCA is later than the reference time, the CW or the backoff value is adjusted to the minimum value, or a half of a previous value, or a ceiling of a half of the previous value, or a floor of a half of the previous value.

By using the CCA parameter adjusting method described above, a possibility of accessing an unlicensed carrier by the station may be improved, ensuring that a transmission latency requirement of Ultra-Reliable and Low Latency Communication (URLLC) traffic data is satisfied.

The above CCA manner may be applied to shared carriers.

A method for executing the CCA by the station is described below.

Firstly, each operator configures unlicensed carriers with different priorities, and different operators different priorities for a same carrier.

For example, priorities of three carriers corresponding to three operators are shown in table 1.

TABLE 1

| Operator No. | Carrier 1 | Carrier 2 | Carrier 3 |
|---|---|---|---|
| 1 | High | Medium | Low |
| 2 | Medium | High | Low |
| 3 | Low | Medium | High |

It is predefined that a carrier of a high priority is configured to send a traffic type having a high requirement on low transmission latency, such as the URLLC traffic type. The CCA with a fixed contention window may be applied to a carrier of a medium priority. An existing LBT process of Category 4 (cat4) is applied to a carrier of a low priority. That is, the existing principle for adjusting the contention window is used for sending a traffic type insensitive to the latency requirement, for example, a massive Machine Type of Communication (mMTC) traffic type or some enhanced mobile broadband (eMBB) traffic types.

To execute the CCA with the random backoff for the carrier of the high priority, a channel priority type is 1, a corresponding maximum contention window is 7 or 3, and the minimum contention window is 3 or 1. The CCA process below may be adopted.

The station checks a channel. If the channel is idle, the station generates a counter N, N=random[0, CW], where CW is the contention window. If the channel is idle, the random number N is decreased and when N is decreased to 0, the data is sent. If the channel becomes busy, the station stops decreasing the random number and continues decreasing N when the channel becomes idle next time.

The CW used each time is dynamically adjusted.

In response to a correct transmission of the data packet, the CW is changed to the minimum value. In response to an incorrect transmission of the data packet, the CW is changed to the minimum value or the ceiling or floor of the half of the original value.

The CW scheduled by the base station and used by a terminal for executing the CCA may be configured by the base station according to a demodulation result of the data packet.

An adjustment process may include the step described below.

The adjustment process of the base station according to k4 (greater than or equal to 1) demodulation results of a physical uplink shared channel (PUSCH) is described below.

If a number of times a Block Error Rate (BLER) is greater than a predefined threshold 1 reaches a threshold, or the base station fails to detect that a UE sends the PUSCH, the CW is adjusted to be the minimum value or decreased by m. If a number of times the BLER is less than a predefined threshold 2 reaches a threshold, the value of the CW is adjusted to the minimum value or the half of the original value.

Alternatively, the CW is directly adjusted according to a result and a number of the acknowledgement (ACK)/non-acknowledgement (NACK) in a previous subframe or the previous Q subframes.

When a plurality of subframes are continuously transmitted in the uplink, if all packets of the subframes are decoded correctly, the value of the CW is changed to the minimum value or decreased by one step size n1. If one packet is decoded incorrectly, the value of the CW value is increased by one step size n2 which may be 1 or 2.

When a time difference between last scheduling and current scheduling of the same UE is greater than a predefined value, an observation window may be between two adjacent uplink subframes, and a reference value is a value of the counter N of a UE at a nearest position from a current scheduling UE in scheduling UEs in the previous uplink subframe or the demodulation result of the PUSCH is used as an adjustment basis for the current scheduling UE.

The method may ensure both the fairness between the operators and the traffic to be sent, for example, a certain low delay traffic can be preferentially sent on the unlicensed carrier, reducing a data transmission delay.

How the CCA method described above ensures the fairness between different systems is described below.

The station which uses the LBT mechanism with random backoff according to the embodiments of the present disclosure and the method for adjusting the contention window may perform the following method in a data transmission process after the successful CCA.

Access opportunities of another system may be provided by a time domain pattern muting or a dynamic on/off manner in the data transmission process.

For example, for the station which adjusts the contention window, some subframes are defined. The subframes may be continuous or discrete. For example, a subframe number satisfies mod (n, T)=k, where n is a system frame number, T is a predefined period and k is an offset. Values of T or K are different for different stations. No matter whether the unlicensed carrier is occupied by the base station or the UE, the base station or the UE cannot send data on the unlicensed subframe.

For example, each subframe with number 6 cannot be transmitted, or a certain period of a sixth subframe of a frame with a system frame number of an integer multiple of 2 cannot be transmitted. The certain period data transmission cannot be performed is at least 34 μs, for example 40 μs, or one symbol or one timeslot. At least a length of a distributed inter-frame spacing (DIFS) is used for an access of a device or another station in a wireless fidelity (WIFI) network system.

Alternatively, a station is forced to stop performing the CCA and the data transmission after continuously transmitting n subframes.

The CCA manner used in sending the to-be-sent traffic on the unlicensed carrier is described below.

The CCA manner for sending the to-be-sent traffic on the unlicensed carrier may further include the manner described below.

The contention mechanism with the random backoff is not used, an enhanced cat2 LBT mechanism is used. The enhanced cat2 LBT mechanism includes only executing one CAA of a predefined length. A detection position is fixed periodically or randomly selected within a certain time window. In response to detecting that signal energy is less than a predefined threshold within a detection duration, the channel is considered to be idle and can be used for sending data.

The process of CCA and data transmission may be described below.

The UE receives downlink control information (DCI) sent by the base station on a certain unlicensed carrier. The information instructs the UE to send an uplink data packet.

A timing relationship between the DCI and sending uplink data by the UE is described below.

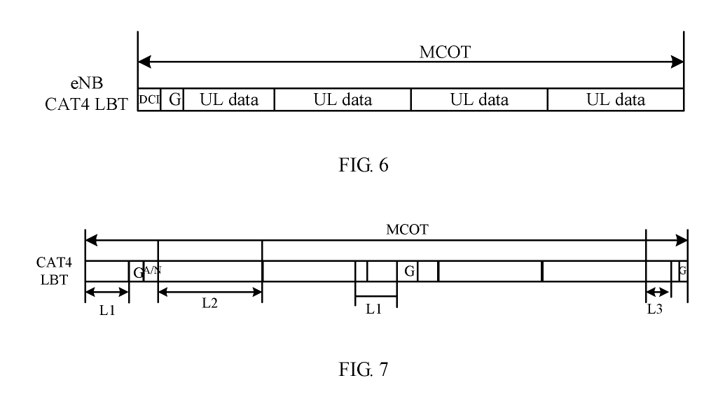

The DCI and the uplink data are in the same subframe. The frame structure is as shown in FIG. 6. A gap between the DCI and the uplink data is used for downlink-to-uplink conversion and for the UE to execute a cat2 CCA.

The process of CCA and data transmission may be described below.

After successfully executing the cat4 LBT mechanism, the base station sends the DCI. The DCI includes at least one of the following:

scheduling indication information including resource allocation information, modulation and coding scheme (MCS) information, Hybrid Automatic Repeat reQuest (HARD) process number information, at least one of indication information of a transmission subframe position or indication information of a scheduling subframe position.

After the UE receives the information, if the CCA succeeds after the gap, the UE transmits the uplink data on the subframe, the UE transmits one subframe or m continuous uplink subframes, where the m subframes cannot exceed a MCOT.

Alternatively, k subframes or k TTIs exist between a subframe where the DCI is located and a subframe for transmitting the uplink data, where k is 1 or 2.

The UE sends the data after successfully executing the CCA before the data transmission.

Alternatively, the UE adopts a non-scheduling access manner. When the UE has a data packet to be sent, the UE simultaneously monitors, on multiple carriers, whether the channel has been occupied by another UE in the same cell or the base station of the UE.

In response to detecting that a certain carrier is occupied by another UE in the same cell or the base station of the UE, the terminal or the station may adopt the enhanced cat2 LBT mechanism.

The CCA and data transmission manner for the URLLC traffic type of a same device on the unlicensed carrier is described below.

A CCA and data transmission method for the URLLC traffic type of a same device on the unlicensed carrier may include the step described below.

The data is transmitted on a contended unlicensed carrier in a manner of deleting TTIs or frequency domain resources of other traffic types.

For example, a certain device performs contention on one or more carriers and continuously sends one or more data packets of the eMBB traffic type or the mMTC traffic type on multiple subframes. In the continuous occupation process, when suddenly a low-latency data packet needs to be sent, the station may delete the data packet being transmitted and send the low-latency data packet on some frequency domain resources at a certain time.

Assuming that a certain station performs a cat4 LBT process to send the data of the mMTC or eMBB traffic type, the station may continuously occupy 10 ms according to control requirements. Assuming that at the fifth subframe in repeatedly continuously transmitting certain data packet of the mMTC traffic type, the station has a new data packet that needs to be sent as soon as possible, the station may delete the repeated packet on the fifth subframe and send the new data packet having a high requirement for low latency. Alternatively, some frequency domain resources of the eMBB traffic type are deleted to transmit the data of the URLLC traffic type.

A method for determining the frame structure by the device according to a CCA success time is described below.

The device flexibly selects a corresponding TTI size according to a time domain length between the CCA success time and a subframe boundary.

The device may also combine the existing candidate TTI lengths into a longer TTI.

For example, the device may support a TTI length including 1 ms, 0.5 ms, 0.25 ms, 0.2 ms and 0.125 ms, which is obtained through a system predefinition or higher-layer semi-static configuration, or the device supports the TTI length or a subframe length of 1, 2, 4, 7 or 14 symbols, each of which has a predefined length.

For example, when the time distance between the CCA success time and the subframe boundary is 0.2 ms, the device may send a subframe or a TTI of 0.2 ms for data transmission.

When the time distance between the CCA success time and the subframe boundary is 0.3 ms, the device may send an initial signal of 0.05 ms and then send a subframe or TTI of 0.25 ms.

When the time distance between the CCA success time and the subframe boundary is 0.35 ms, the device may send a subframe of length 0.2 ms and then send a subframe or TTI of 0.125 ms; or may send a subframe of length 0.125 ms and then send a sub-frame or TTI of 0.2 ms.

The device may also select a transmission block (TB) size to be transmitted according to different TTI lengths. For example, a small data packet is transmitted with a short TTI or subframe, and a large data packet is transmitted with a long subframe.

In this way, the occupation signal may be reduced or avoided to improve a resource utilization rate.

Similarly, the device is limited by the MCOT, so for a length of an ending subframe, a corresponding TTI or subframe length thereof is selected according to the subframe boundary and the MCOT, or a corresponding number of symbols thereof is selected according to the subframe boundary and the MCOT.

For example, if the occupation time is 6 ms and the device has occupied 0.25 ms before a complete subframe of 1 ms, 0.75 ms is left after the device continuously transmits 5 complete subframes of 1 ms, and the device may send a subframe of 0.5 ms and then send another subframe of 0.25 ms to avoid wasting resources.

In addition, the frame structure for the data transmission may also be adjusted according to the TTI length. As shown in FIG. 7, after the LBT succeeds, a station 1 first sends the with a TTI of length L1, for example, 0.5 ms; after receiving the data, a station 2 directly feeds back the ACK/NACK without performing LBT after the gap, which occupies 0.75 ms in total. Next, the station 1 continuously transmits two subframes with a TTI of length L2, for example, 1 ms. There is only data of length L1 or only the control information is sent after the TTI of length L2, so the TTI of length L1 is used for the data transmission.

In this way, the occupation signal may be reduced as much as possible to improve the resource utilization rate.

A data receiving process of the receiving terminal is described below.

In the case of downlink data, the transmitting terminal is the base station and the receiving terminal is a user equipment. The TTI length is determined in the two manners described below.

In a manner 1, the UE determines the TTI length of the transmitting terminal according to a signaling indication.

In a manner 2, the UE performs blind detection according to the candidate TTI lengths.

In the case of the uplink data, the TTI length is determined by the receiving terminal in the manners described below.

When the UE gains an access to the system in an autonomous manner rather than through scheduling of the base station, the TTI length is determined by the UE itself according to the CCA success time. In this case, the base station does not know the TTI length used by the UE and performs blind detection according to multiple TTI lengths predefined by the system. Alternatively, the UE carries indication information of the TTI length used for the data transmission when sending the data.

When the UE performs the data transmission based on the scheduling of the base station, the TTI length used for the data transmission is indicated by the base station and the base station receives the data according to a configured TTI length.

When the TTI length is not indicated by the base station, the base station performs the blind detection according to the multiple TTI lengths predefined by the system.

The TTI length may be indicated by the transmitting terminal in the manners described below.

The TTI length of each subframe within the MCOT is included in downlink control information or uplink control information, for example, the occupied subframe and its corresponding TTI length are indicated in a bitmap. For example, the system defines four TTI lengths, each of which is represented by 2 bits. If the station sends four subframes after occupying the channel, 8 bits may be used for representing the TTI lengths of the subframes one by one. Alternatively, the station may merely indicate the TTI length of a first subframe and the TTI length of a last subframe, and the TTI length of the intermediate subframe uses a maximum one of predefined TTI lengths.

Described below is a case where the station executing the CCA determines the contention window according to the indication information received from another predetermined node.

For example, when a node performing the CCA is the UE, the another predetermined node may be the base station. The base station may inform the UE of an adjusted contention window via indication signaling.

The base station may inform the UE by way of joint coding with other indication signaling. For example, the signaling indication after the joint coding of a LBT type, a starting symbol position and the CW is shown in table 2 below.

TABLE 2

| | | Starting Posiiton of Data | |
|---|---|---|---|
| Signaling | LBT Type | Channel | CW Size |
| 000 | Enhanced Cat2 | Symbol #0 | N/A |
| 001 | Enhanced Cat2 | Start after 25 us from | N/A |
| | | beginning of symbol #0 (if | |
| | | supported) | |
| 010 | Enhanced Cat2 | Symbol #1 | N/A |
| 011 | Enhanced Cat.4 | Symbol #0 | 3 |
| | LBT | | |
| 100 | Enhanced Cat.4 | Symbol #0 | 7 |
| | LBT | | |
| 101 | Enhanced Cat.4 | Symbol #1 | 3 |
| | LBT | | |
| 110 | Enhanced Cat.4 | Symbol #1 | 7 |
| | LBT | | |
| 111 | No LBT | Start after 16 us from | N/A |
| | | beginning of symbol #0 (if | |
| | | supported) | |

The enhanced cat2 and the enhanced cat4 in Table 2 are the above-mentioned LBT methods according to the embodiments of the present disclosure.

The UE performs the CCA and the data transmission according to the indication information.

The station in the embodiment may be a Node B, an evolved Node B (eNode B), a home Node B, a relay node (RN), a user equipment (UE), or other devices capable of using the unlicensed carrier.

It is to be noted that the principle or method for adjusting the contention window of the CCA process in the present disclosure may also be used for adjusting a random backoff value. The station directly adjusts the random backoff value according to the principle.

In addition, an embodiment of the present disclosure further provides a computer-readable medium storing programs for data transmission. The programs, when executed by a processor, implement the steps of the data transmission method according to the embodiment shown in FIG. 1.

In addition, an embodiment of the present disclosure further provides a computer-readable medium storing programs data transmission. The data transmission, when executed by a processor, implement the steps of the data transmission method according to the embodiment shown in FIG. 2.

It will be understood by those skilled in the art that functional modules/units in all or part of the steps of the method, the system and the apparatus disclosed above may be implemented as software, firmware, hardware and appropriate combinations thereof. In the hardware implementation, the division of the functional modules/units mentioned in the above description may not correspond to the division of physical components. For example, one physical component may have several functions, or one function or step may be implemented jointly by several physical components. Some or all components may be implemented as software executed by processors such as digital signal processors or microcontrollers, hardware, or integrated circuits such as application specific integrated circuits. Such software may be distributed on a computer-readable medium, which may include a computer storage medium (or a non-transitory medium) and a communication medium (or a transitory medium). As is known to those skilled in the art, the term, computer storage medium, includes volatile and nonvolatile, removable and non-removable medium implemented in any method or technology for storing information (such as computer-readable instructions, data structures, program modules or other data). The computer storage medium includes, but is not limited to, a RAM, a ROM, an EEPROM, a flash memory or other memory technologies, a CD-ROM, a digital versatile disc (DVD) or other optical disc storage, a magnetic cassette, a magnetic tape, a magnetic disk storage or other magnetic storage apparatuses, or any other medium used for storing desired information and accessed by a computer. In addition, as is known to the person having ordinary skill in the art, the communication medium generally includes computer-readable instructions, data structures, program modules or other data in modulated data signals such as carriers or other transmission mechanisms, and may include any information delivery medium.

Although the embodiments disclosed by the present disclosure are as described above, the content thereof is merely embodiments for facilitating the understanding of the solutions of the present disclosure and is not intended to limit the present disclosure. Any person having ordinary skill in the art of the present disclosure can make any modifications and changes in the forms and details of the implementation without departing from the solutions disclosed by the present pertains, but the scope of protection defined by the present pertains is still subject to the scope defined by the appended claims.

### INDUSTRIAL APPLICABILITY

The embodiments of the present pertains provide a data transmission method and apparatus, which provides feasibility of sending traffic with a high requirement for low latency on an unlicensed carrier, ensures fairness between operators and fairness between different systems, enables to-be-sent traffic with a low latency requirement to be preferentially sent on the unlicensed carrier, and reduces a data transmission latency.

1. A data transmission method, comprising:
determining a carrier priority to be used according to a traffic type;
performing channel contention by performing a clear channel assessment (CCA) process according to the carrier priority and using a preset CCA mechanism; and
sending data of the traffic type on the contended channel.

2. The method of claim 1, wherein the preset CCA mechanism comprises: not executing the CCA, executing one-detection CCA, and executing the CCA with random backoff.

3. The method of claim 2, wherein the executing the CCA with random backoff comprises:
determining that the CCA succeeds in response to determining that a backoff value decreases to a predetermined value; or
executing another CCA with a predefined length at a predefined time after the backoff value decreases to the predetermined value; or
executing the CCA by adjusting a listen before talk (LBT) contention window or a CCA backoff value.

4. (canceled)

5. The method of claim 3, wherein adjusting the LBT contention window or the CCA backoff value comprises one of:
decreasing the LBT contention window or the CCA backoff value in response to determining that a data packet transmitted on a predetermined reference subframe is transmitted incorrectly;
increasing the LBT contention window or the CCA backoff value in response to determining that the data packet transmitted on the predetermined reference subframe is transmitted correctly;
decreasing the LBT contention window or the CCA backoff value in response to determining that a transmission data packet is not successfully sent at a predetermined reference time or is successfully sent after the predetermined reference time;
increasing the LBT contention window or the CCA backoff value in response to determining that the transmission data packet is successfully sent before the predetermined reference time;
decreasing the LBT contention window or the CCA backoff value in response to determining that a number of times a channel is busy within a predetermined time exceeds a first threshold;
increasing the LBT contention window or the CCA backoff value in response to determining that a number of times the channel is idle within the predetermined time exceeds a second threshold;
decreasing the LBT contention window or the CCA backoff value in response to determining that the number of times the channel is busy, a number of channel busy timeslots, a ratio of the number of channel busy timeslots to a total number of CCA timeslots, or a number of failed CCAs within the predetermined time exceeds a third threshold;
increasing the LBT contention window or the CCA backoff value in response to determining that the number of times the channel is idle, a number of channel idle timeslots, a ratio of the number of channel idle timeslots to the total number of CCA timeslots, or a number of successful CCAs within the predetermined time exceeds a fourth threshold; and
determining a size of the LBT contention window or a size of the CCA backoff value according to indication information sent by a predetermined node.

6. The method of claim 5, wherein the decreasing the LBT contention window or the CCA backoff value comprises: adjusting the LBT contention window or the CCA backoff value to a preset minimum value or a half of a current value or a ceiling of the half of the current value or a floor of the half of the current value; and
wherein the increasing the LBT contention window or the CCA fallback value comprises:
doubling the LBT contention window or the CCA backoff value.

7. (canceled)

8. The method of claim 2, wherein the executing one-detection CCA comprises:
executing one CCA in each frame period, wherein a starting position of the one CCA is randomly selected within a preset time window, wherein the preset time window is one timeslot or one subframe or one orthogonal frequency division multiplexing (OFDM) symbol.

9. The method of claim 1, wherein the sending data of the traffic type on a contended channel comprises: muting according to a predefined time domain pattern, or sending the data of the traffic type in a dynamic on/off manner.

10. The method of claim 2, wherein in response to not executing the CCA, sending the data of the traffic type comprises: transmitting the data of the traffic type on a contended unlicensed carrier in a manner of deleting a transmission time interval (TTI) or a frequency domain resource of other traffic types except the traffic type.

11. The method of claim 1, wherein before the data of the traffic type is sent, the method further comprises: determining a length of a transmission time interval (TTI) in a data transmission, or selecting the length of the TTI in the data transmission from candidate TTI lengths.

12. The method of claim 11, wherein the determining a length of a TTI in the data transmission comprises one of:
determining a length of an initial TTI or a length of an initial subframe within a channel occupation time according to a time domain length between a CCA success time and a subframe boundary;
determining a length of a last TTI or a length of a last subframe within the channel occupation time according to a difference between an occupied time and a maximum channel occupation time (MCOT); and
determining a length of a TTI within the channel occupation time according to a predefinition or network configuration.

13. The method of claim 11, wherein the selecting the length of the TTI in the data transmission from candidate TTI lengths comprises:
selecting, from the candidate TTI lengths, a TTI length closest to t1 as a length of an initial subframe in the data transmission;
selecting, from the candidate TTI lengths, a TTI length closest to t2 as a length of a last subframe in the data transmission; and
selecting, from the candidate TTI lengths, more than two TTI lengths, and combining the more than two TTI lengths to a subframe length closest to t1 or t2 as a subframe length in the data transmission;
wherein t1 is a time domain length between a CCA success time and a subframe boundary, and t2 is a difference between an occupied time and a maximum channel occupation time (MCOT).

14. The method of claim 12, wherein the length of the initial TTI and the length of the last TTI within the channel occupation time are less than or equal to a length of any TTI between the initial TTI and the last TTI.

15. A data transmission method, comprising:
determining a transmission time interval (TTI) length in a data transmission; and
receiving transmission data on a corresponding carrier according to the TTI length.

16. The method of claim 15, wherein the determining a TTI length in a data transmission comprises: performing blind detection, according to a predefined candidate TTI set, on the corresponding carrier to obtained the TTI length, or obtaining the TTI length according to indication information.

17-30. (canceled)

31. A data transmission apparatus, comprising:
a processor; and
a memory communicably connected to the processor for storing instructions executable by the processor,
wherein execution of the instructions by the processor cause the processor to:
determine a carrier priority to be used according to a traffic type;
perform channel contention by performing a clear channel assessment (CCA) process according to the carrier priority and using a preset CCA mechanism; and
send data of the traffic type on the contended channel.

32. The data transmission apparatus according to claim 31, wherein the execution of the instructions by the processor cause the processor to: determine a length of a transmission time interval (TTI) in a data transmission, or select the length of the TTI in the data transmission from candidate TTI lengths.

33. The data transmission apparatus according to claim 32, wherein the length of the TTI in the data transmission is determined in the following manners:
determining a length of an initial TTI or a length of an initial subframe within a channel occupation time according to a time domain length between a CCA success time and a subframe boundary; or
determining a length of a last TTI or a length of a last subframe within the channel occupation time according to a difference between an occupied time and a maximum channel occupation time (MCOT); or
determining a length of a TTI within the channel occupation time according to a predefinition or network configuration.

34. The data transmission apparatus according to claim 32, wherein the processor selects the length of the TTI in the data transmission from the candidate TTI lengths in the following manners:
selecting, from the candidate TTI lengths, a TTI length closest to t1 as a length of an initial subframe in the data transmission;
selecting, from the candidate TTI lengths, a TTI length closest to t2 as a length of a last subframe in the data transmission; or
selecting, from the candidate TTI lengths, more than two TTI lengths, and combining the more than two TTI lengths to a subframe length closest to t1 or t2 as a subframe length in the data transmission;
wherein t1 is a time domain length between a CCA success time and a subframe boundary, and t2 is a difference between an occupied time and a maximum channel occupation time (MCOT).

35. A data transmission apparatus, comprising:
a processor; and
a memory communicably connected to the processor for storing instructions executable by the processor,
wherein execution of the instructions by the processor cause the processor to perform the data transmission method according to claim 15.

36. The data transmission apparatus according to claim 35, wherein the processor is configured to determine the TTI length in the data transmission in the following manner:
performing blind detection, according to a predefined candidate TTI set, on the corresponding carrier to obtain the TTI length, or
obtaining the TTI length according to indication information.
